(19) United States
(12) Patent Application Publication
(10) Pub. No.: US 2025/0317246 A1
(43) Pub. Date: Oct. 9, 2025

(54) REALTIME TROPOSPHERIC DUCTING MITIGATION

(71) Applicant: T-MOBILE INNOVATIONS LLC, Overland Park, KS (US)

(72) Inventor: Akin OZOZLU, McLean, VA (US)

(21) Appl. No.: 18/629,326

(22) Filed: Apr. 8, 2024

(51) Int. Cl. H04L 5/00; H04L 5/14; H04W 72/541

(52) U.S. Cl. CPC H04L 5/0035; H04L 5/14; H04W 72/541

(57) ABSTRACT

Systems and methods are provided for mitigating atmospheric ducting within a wireless telecommunication network. The disclosure includes determining the configuration of user equipment (UE) within the coverage area of a victim base station, which employs a primary cell operating with time domain duplexing (TDD) and a secondary cell operating with frequency domain duplexing (FDD). Subsequently, a scheduler associated with the victim base station directs uplink communications to be transmitted via the secondary cell, thereby isolating the primary cell during periods of interference.

### SUMMARY

The present disclosure is directed to improving the mitigation of the effects of tropospheric ducting within a telecommunication network, substantially as shown and/or described in connection with at least one of the Figures, and as set forth more completely in the claims.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 depicts a network environment in which implementations of the present disclosure can be employed, in accordance with aspects herein;

FIG. 3 depicts a diagram of tropospheric ducting occurring in a network environment;

FIG. 4 depicts a flow diagram of a first method for mitigating tropospheric ducting interference in a wireless telecommunication network in accordance with aspects herein; and

FIG. 5 depicts a flow diagram of a second method for mitigating tropospheric ducting interference in a wireless telecommunication network in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” is used to refer to network access technology for the provision of wireless telecommunication services from a base station to one or more electronic devices, such as an eNodeB, gNodeB, etc. The term “cell” is used to describe one or more hardware and software components of a base station that are configured to provide wireless communication service to a geographic area.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, time of flight (TOF) interference is a situation where radio frequency signals from a wireless communication network are received much farther from the transmitter than desired. In some cases, signals intended to cover distances of 10 miles or less can travel much further. They can extend dozens or even hundreds of mile. Tropospheric ducting, a meteorological phenomenon where layers of warm and cold air form at different altitudes, often causes this. If warm air is sandwiched between two cold layers, it creates a duct that traps radio frequency signals, making them travel farther than usual. This can lead to interference and degrade the user experience.

Conventionally, systems and methods to address radio frequency signal interference from tropospheric ducting involve forecasting potential events and optimizing network configurations to minimize interference. Specifically, under certain weather conditions, base station antennas can be tilted to avoid intercepting interfering frequencies from distant stations. Transmission power can also be adjusted to maintain a stable link. However, the effectiveness of these adjustments is constrained by the capabilities of the wireless network. Moreover, tropospheric ducting is unpredictable, depending on weather conditions and atmospheric temperature profiles, making it difficult to manage communication systems effectively. Conventional interference mitigation involves reconfigurations of antenna or signal characteristics. Even with accurate predictions or quick detection, this process is slow and imprecise. It can also lead to unintended consequences, such as reduced coverage due to antenna downtilting.

Unlike conventional solutions, this disclosure introduces techniques to mitigate atmospheric ducting in wireless telecommunication networks, diverging from conventional solutions. These techniques involve predictive and responsive strategies. In one aspect, the techniques predict the likelihood of TOF interference in the future using environmental and historical data. This prediction leads to a proactive adjustment in the configuration of UE within the coverage area of a victim base station, which operates using both a primary cell and a secondary cell. Upon subsequent confirmation of TOF interference, a scheduler within the victim base station is triggered to redirect all uplink communication from the UE to be transmitted via the secondary cell, effectively isolating the primary cell from uplink transmissions during the interference period. These techniques ensure continuous and efficient communication, mitigating the impact of atmospheric ducting.

Accordingly, a first aspect of the present disclosure provides a system comprising one or more computer processing components configured to perform operations. The operations comprise predicting that time of flight interference will likely occur at a first time. The operations next determine that a user equipment within a coverage area of a victim base station is configured to communicate with the victim base station using a primary cell and a secondary cell, wherein the primary cell and the secondary cell are configured to use frequency domain duplexing (FDD). Additionally, the operations instruct the UE prior to the first time to re-configure the primary cell to use time domain duplexing (TDD). Next, the operations determine, at a second time subsequent to the first time that time of flight interference is occurring for the victim base station and based on the determination that time of flight interference is occurring for the victim base station, causing a scheduler within the victim base station to communicate to the UE that all uplink communication to be sent from the UE to the victim base station is scheduled to be sent via the secondary cell and no uplink communication to be sent from the UE to the victim base station is scheduled to be sent via the primary cell.

A second aspect of the present disclosure comprises a method that monitors a set of environmental parameters to predict the occurrence of TOF interference. The method further comprises identifying a UE within a service range of a victim base station, where the victim base station operates with a primary cell using TDD and a secondary cell using FDD. Additionally the method comprises verifying the occurrence of TOF interference and directing a scheduler within the victim base station, in response to the TOF interference, to that all uplink communication from the UE is to be transmitted exclusively via the secondary cell.

Another aspect of the present disclosure is directed to a non-transitory computer readable media having instructions stored thereon that, when executed by one or more computer processing components, cause the one or more computer processing components to perform a method that determines TOF interference is occurring for the victim base station, wherein the victim base station is configured to operate using a primary cell and a secondary cell to wirelessly communicate with the operating within a geographic area served by the victim base station, wherein the primary cell is configured to use TDD and the secondary cell is configured to use FDD. This method further comprises, based on the determination that time of flight interference is occurring for the victim base station, causing a scheduler within the victim base station to communicate to the UE that all uplink communication to be sent from the UE to the victim base station is scheduled to be sent via the secondary cell and no uplink communication to be sent from the UE to the victim base station is scheduled to be sent via the primary cell

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 can be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 can be removable, non-removable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which can be built in computing device 100. Illustrative I/O components 112 include a microphone, joystick, game pad, satellite dish, scanner, printer, wireless device, etc.

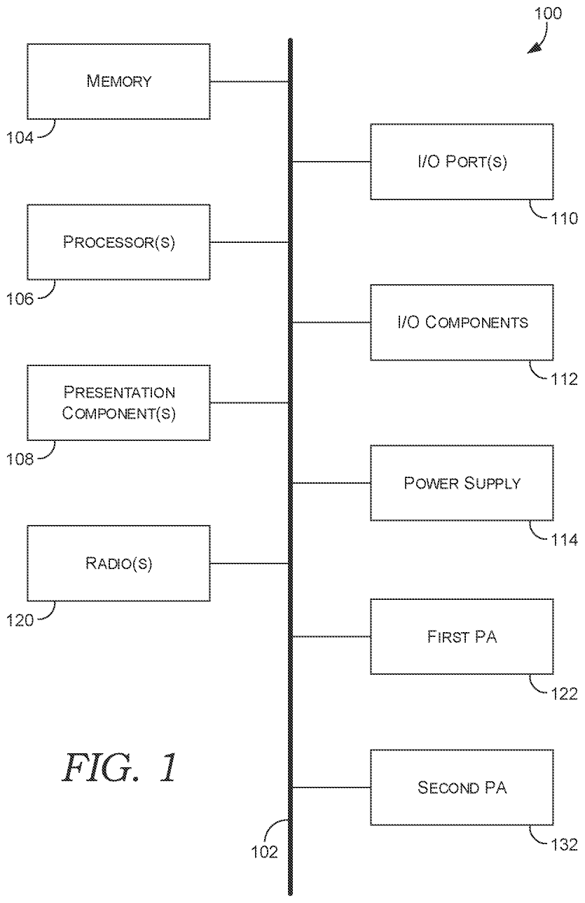

The radio 120 represents one or more radios that facilitate communication with one or more wireless networks using one or more wireless links. While a single radio 120 is shown in FIG. 1, it is expressly contemplated that there can be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g., a second transmitter). Illustrative wireless telecommunications technologies include CDMA, GPRS, TDMA, GSM, and the like. The radio 120 can carry wireless communication functions or operations using any number of desirable wireless communication protocols, including 802.11 (Wi-Fi), WiMAX, LTE, 3G, 4G, LTE, 5G, NR, VOLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

As used herein the term “LTE” refers to the 4G Long-Term Evolution standard for cellular network. Additionally, as used herein the term “5G” refers to the 5G is the fifth-generation technology standard for cellular networks. Both LTE and 5G enable communications between a network and a user device, where an air interface is the radio frequency portion of the circuit between the user device and the network. LTE protocols can be typically deployed using frequency domain duplexing technology, where for a brief overview, up-link and downlink signals are assigned certain frequencies of bandwidth to facilitate communication between the user device and the network. Whereas, 5G protocols can be typically deployed using time domain duplexing technology, where for a brief overview, up-link and downlink signals are assigned timeslots for broadcast or receiving to facilitate communication between the user device and the network.

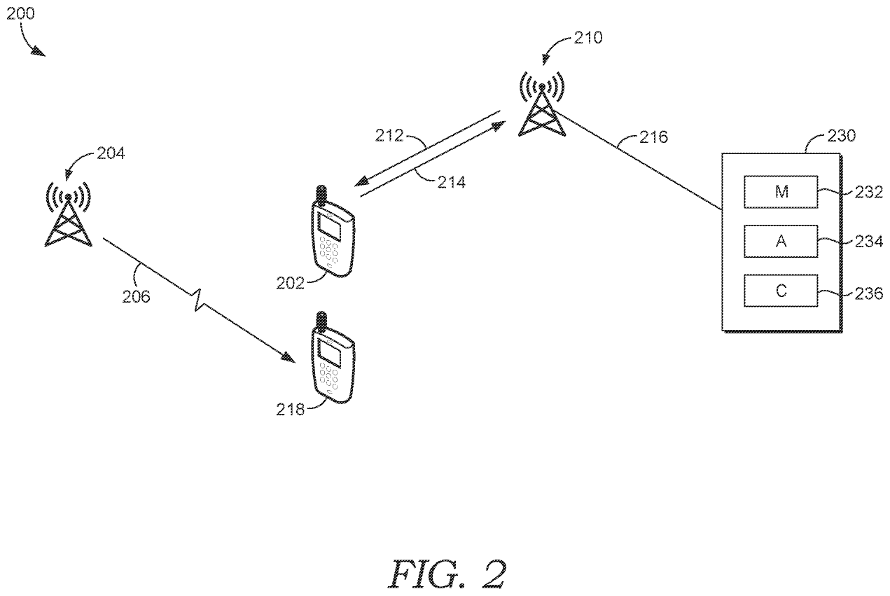

Turning now to FIG. 2, an exemplary network environment is illustrated in which implementations of the present disclosure can be employed. Such a network environment is illustrated and designated generally as network environment 200. At a high level the network environment 200 comprises a UE 202, one or more base stations, and one or more networks. Though the UE 202 is illustrated as a cellular phone, a UE suitable for implementations with the present disclosure can be any computing device having any one or more aspects described with respect to FIG. 1. Similarly, though the one or more base stations are illustrated as macro cells on a cell tower, any scale or form of access point acting as a transceiver station for wirelessly communicating with a UE, including small cells, pico cells, and the like, are suitable for use with the present disclosure. The network environment 200 is but one example of a suitable network environment and is not intended to suggest any limitation as to the scope of use or functionality of the disclosure. Neither should the network environment 200 be interpreted as having any dependency or requirement to any one or combination of components illustrated.

The network environment 200 comprises one or more base stations to which the UE 202 can potentially connect to (also referred to as ‘camping on’, ‘attaching’ in the industry). Though the network environment 200 is illustrated with three distinct base stations, one skilled in the art will appreciate that more or fewer base stations can be present in any particular network environment suitable for use with the present disclosure. The one or more base stations of network environment 200 can comprise one or more of an aggressor base station 204 and a victim base station 210. Each of the one or more base stations of the network environment 200 is configured to wirelessly communicate with UEs, such as the UE 202. In aspects, any of the one or more base stations can communicate with a UE using any wireless telecommunication protocol desired by a network operator, including but not limited to 3G, 4G, 5G, 6G, 802.11x and the like. Relevant to the present disclosure, each of the one or more base stations is associated with a network identifier (e.g., a Public Land Mobile Network (PLMN) number). Each of the one or more base stations can be generally said to be configured to communicate with one or more UEs located within a geographical area. A geographical area for any particular base station can be referred to as the “coverage area” of the base station or simply as a “cell.” In some aspects, each cell is defined by an area in which signaling between a particular UE and the base station is usable for any purpose. Each of the base stations of the network environment 200 can be used to provide coverage to a plurality of cells, wherein one or more of the plurality of cells at least partially overlap; for example, the victim base station 210 can provide coverage to a first cell and a second cell, wherein the first cell and the second cell at least partially overlap. Generally, each base station of the one or more base stations can comprise one or more base transmitter stations, radios, antennas, antenna arrays, power amplifiers, transmitters/receivers, digital signal processors, control electronics, GPS equipment, and the like.

In some aspects, each of the base stations can utilize a plurality of cells, wherein the cells are operating using the same telecommunications protocol. For example, the victim base station 210 can operate multiple cells, all utilizing a single RAT, such as TDD. In other aspects, each of the base stations can utilize a plurality of cells, wherein the cells are operating using a plurality of telecommunication protocols as desired by the network. For example, the victim base station 210 can utilize a first cell providing coverage using a first RAT and a second cell using providing coverage using a second RAT. The coverage of the first cell and the second cell can be substantially similar in coverage area and overlap. The first and second cells can be located on the same base station or can be geographically separated but controlled by the victim base station 210. For example, the victim base station can have the first or primary cell which operates using TDD and the second or secondary cell which operates using FDD. The aggressor base station 204 and the victim base station 210 can operate using at least one of the same telecommunication protocols, such as TDD or FDD.

Each base station of the network environment 200 is configured to transmit downlink signals to one or more UEs, such as the UE 202 and to receive uplink signals therefrom. For the purposes of network environment 200, the victim base station 210 transmits downlink signals on a first downlink 212, the victim base station 210 receives uplink signals on a first uplink signal 214, and the aggressor base station 204 transmits downlink signals on a third downlink 206 to a UE such as a second UE 218.

Network environment 200 includes UE 202 configured to wirelessly communicate with the one or more base stations of the network environment 200. The UE 202 can take on a variety of forms, such as a personal computer (PC), a user device, a smart phone, a smart watch, an extended reality (XR) device, Internet of Things (IoT) device, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device that comprising any one or more feature of computing device 100 of FIG. 1.

In order to connect to a base station, UE 202 employs an array of radio access technologies, encompassing both 5G and LTE standards. The UE 202 can operate in multi-mode functionality. A component of this operation is the implementation of carrier aggregation. In one aspect, the UE 202 can operate using carrier aggregation in a TDD+FDD mode. In another aspect, the UE 202 can operate in an FDD+FDD mode. Alternatively, the UE 202 can operate in a TDD+TDD mode.

The network environment 200 additionally comprises one or more hardware and/or software components that, together, make up a TOF mitigation engine 230. The TOF mitigation engine 230 can comprise a monitor 232, an analyzer 234, and a controller 236. The monitor 232 is generally configured to determine that TOF interference is taking place and affecting the ability of the UE 202 to utilize the victim base station 210. Specifically, the UE 202 can be having trouble communicating with one or more of a victim cell on the victim base station 210.

The monitor 232 is generally configured to determine that TOF interference is taking place in a first geographic region, in which the UE 202 is located. Any suitable means for determining the existence of TOF interference would be suitable for use with the present disclosure, including the use of tropospheric ducting forecasts, observations of the third downlink 206 comprising a cell identifier of the aggressor base station 204 (combined with a determination that the aggressor base station 204 is located greater than a predetermined threshold distance from the victim base station 210), or by determining that a signal parameter is sufficiently different at a first portion of an uplink time period (e.g., an uplink subframe) when compared to a second, later, portion of the uplink time period.

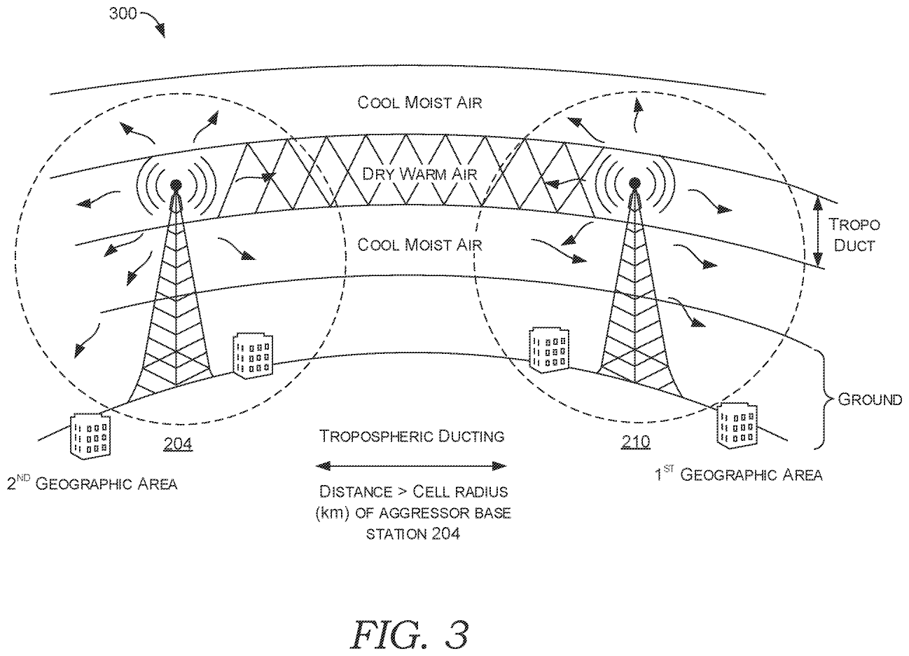

An illustration of tropospheric ducting is presented in FIG. 3. As illustrated, in network environment 300, the aggressor base station 204 from FIG. 2, located in a second geographic region, can broadcast radio frequency signals, which become trapped in a layer or duct of dry, warm air positioned in between layers of cool, moist air. These radio frequency signals travel a greater distance than intended, beyond the cell radius of the aggressor base station 204, to the victim base station 210, located in the first geographic region. When signals from the aggressor base station 204 are of sufficiently proximate frequencies, they can cause interference at the victim base station 210, particularly when the victim base station 210 utilizes TDD and the downlink signals from the aggressor base station 204 arrive during an uplink time period of the victim base station 210. That is, as the victim base station 210 can realize noise from the downlink signals of the aggressor base station 204 when the victim base station 210 is scheduled to be receiving uplink signals from a UE.

Returning to FIG. 2, the monitor 232 can determine that TOF interference is affecting the victim base station 210 based on one or more signal parameters being sufficiently different during different portions of an uplink time period (e.g., an uplink subframe). The monitor 232 can utilize observations of the one or more signal parameters by the victim base station 210 or measurement reports from one or more UEs within a predetermined threshold distance of the victim base station 210. The one or more signal parameters can comprise a signal strength, signal quality, or noise value (e.g., signal to interference noise ratio (SINR)).

The monitor 232 can use observations of these signal parameters made by the victim base station 210, or it can use measurement reports from one or more UEs located within a predetermined distance from the victim base station 210. In aspects, the first point in the uplink time period can be a configurable threshold amount of time from the beginning of the uplink time period. The monitor can compare the first observation to a second observation of the one or more signal parameters at a second point in the uplink time period. In aspects, the second point in the uplink time period is subsequent to the first point and can be a configurable threshold amount of time from the end of the uplink time period. For example, if the uplink time period is 10 ms, the first point can be 1 ms after the start of the uplink time period and the second point can be 8 ms after the start of the uplink time period. If one or more values of the one or more signal parameters at the first point are within a threshold range of the one or more values of the one or more signal parameters at the second point, the monitor 232 can determine that TOF interference is not occurring (or that it cannot be mitigated). If, on the other hand, the one or more values are beyond the threshold range, the monitor 232 can determine that TOF interference is occurring and communicate such an indication to the analyzer 234. In one non-limiting example, the one or more signal parameters can be SINR and the monitor 232 can compare the SINR at 1 ms and 8 ms in to a 10 ms uplink subframe. If the predetermined threshold range is 10 dB, and a SINR of 5 dB is observed in the first geographic area at 1 ms, this situation initiates an assessment. Subsequently, if a SINR of 20 dB is noted in the same geographic area at 8 ms, monitor 232 can ascertain that TOF interference is impacting the victim base station 210. Conversely, should the SINR in the first geographic area be recorded at 5 dB at 1 ms and 10 dB at 8 ms, then monitor 232 concludes that TOF interference is either not present or cannot be mitigated. In this case, the TOF mitigation engine 230 will not initiate any corrective actions.

The analyzer 234 can, in some aspects, identify or predict that TOF interference will occur at a time in the future for the victim base station 210. This prediction is based on a comprehensive analysis that includes comparing a predicted level of TOF interference against a predetermined threshold. If this threshold is exceeded, it triggers specific actions to be taken. The prediction process involves data analytics, where the analyzer 234 collects and processes various data types. This data includes atmospheric conditions, historical communication patterns, and real-time network performance metrics. By integrating this data, the analyzer 234 constructs predictive models capable of forecasting the likelihood and timing of TOF interference. Additionally, the analyzer 234 can incorporate data from external sources such as weather prediction services, which provide valuable insights into atmospheric conditions conducive to TOF interference. By utilizing these tools and considering the predetermined threshold, the analyzer 234 can enable preemptive measures to mitigate the impact of TOF interference on network communications.

Before the onset of the predicted TOF interference, the analyzer 234 identifies that, the current configuration of the victim base station 210 is set to an FDD+FDD mode. Upon predicting future TOF interference and determining that it exceeds the predetermined threshold, the analyzer 234 communicates with the controller 236, instructing it to transition the base station's carrier aggregation configuration from its current FDD+FDD mode to a hybrid TDD+FDD mode at a time prior to the predicted time of the future TOF interference. Specifically, the primary cell is switched from FDD to TDD.

Controller 236, in response to the input from analyzer 234, can initiate network reconfigurations by engaging a scheduler within the victim base station 210. This scheduler initiates a re-configuration or re-scheduling of uplink signals from the UE 202. The scheduler modifies the scheduling by transmitting instructions to UE 202 via the first downlink 212. These instructions direct UE 202 not to send or schedule any communications over the first uplink signal 214 to the victim base station 210 using TDD communications. As such, UE 202 is directed to exclusively use the secondary cell, which is configured for FDD, for all uplink communications with the victim base station 210. In other aspects, the scheduler can schedule a majority of uplink signals to be sent via the secondary cell, or FDD cell, and a smaller portion to be sent via the primary cell, or TDD cell.

In a subsequent aspect, the TOF mitigation engine 230 continues monitoring of TOF interference across the network. If the interference or TOF interference diminishes or falls beneath a predefined threshold, the engine—consisting of the monitor 232, analyzer 234, and controller 236—determines that TOF interference is no longer affecting the victim base station 210. Following this determination, UE 202 is instructed to revert to using both the primary cell and the secondary cell for uplink communications with the victim base station 210

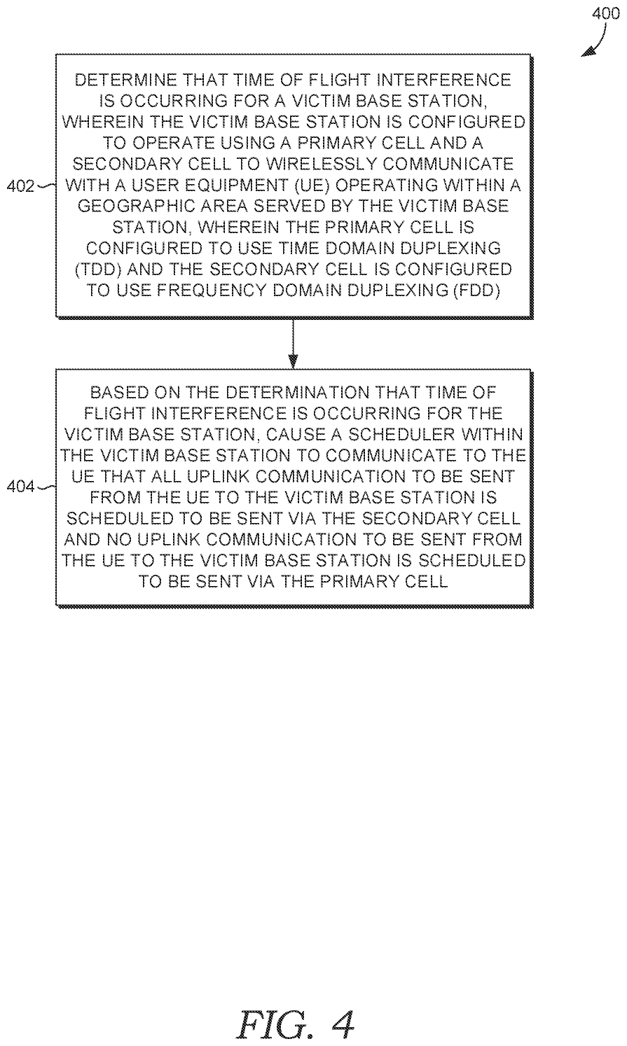

FIG. 4 presents a flow diagram of a method for mitigating tropospheric ducting by switching the scheduling of uplink signals from UE 202, as per the described aspects. The method 400 initiates at block 402 with the detection of TOF interference affecting a victim base station, where the victim base station communicates with the UE in a defined geographic area using a primary cell with TDD and a secondary cell with FDD. Proceeding to block 404, upon confirming TOF interference at the victim base station, a scheduler within the base station is prompted to instruct the UE that all uplink communications should be routed through the secondary cell using FDD, and that no uplink communication should be scheduled through the primary cell using TDD.

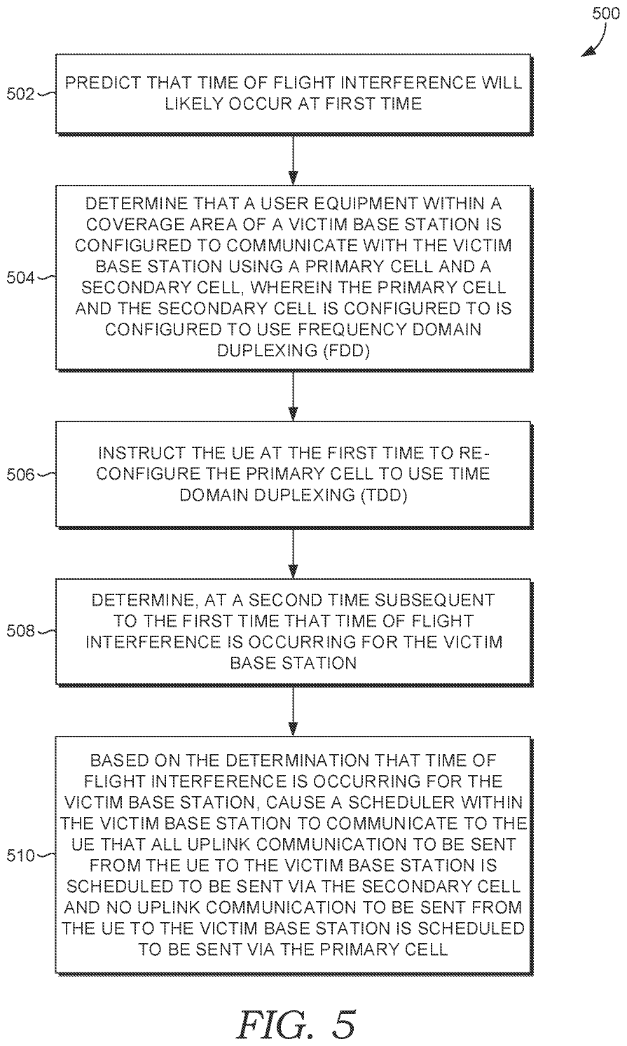

FIG. 5 illustrates a flow diagram of a method for proactively managing communication modes of UE 202 to mitigate tropospheric ducting, in line with the described technological advancements. The method 500 commences at block 502 with a predictive analysis, indicating that TOF interference is expected at a future time, based on an integrated assessment of atmospheric conditions, historical data patterns, and real-time sensor measurements. At block 504, the assessment confirms that the UE is within the coverage area of the victim base station, capable of communication through a primary cell initially set to FDD and a secondary cell also using FDD. In response to the predictive analysis, block 506 involves instructing the UE to preemptively reconfigure the primary cell to TDD.

Subsequently, at block 508, a real-time analysis is performed, which verifies the occurrence of TOF interference, involving signal degradation metrics and error rates over the primary cell, now operating with TDD. Based on this verification, block 510 depicts the scheduler within the victim base station executing a series of operations. These operations include communicating modified scheduling signals to the UE that direct all uplink communication to be exclusively scheduled to be sent via the secondary cell, operating with FDD. This includes monitoring the quality of service experienced by the UE to determine the effectiveness of the mitigation method and adjusting the broadcasting power or frequency as needed. Additionally, the method allows for the reversion of the primary cell to FDD upon the cessation of TOF interference.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and can be employed without reference to other features and subcombinations and are contemplated within the scope of the claims

In the preceding detailed description, reference is made to the accompanying drawings, which form a part hereof wherein like numerals designate like parts throughout, and in which is shown, by way of illustration, embodiments that can be practiced. It is to be understood that other embodiments can be utilized and structural or logical changes can be made without departing from the scope of the present disclosure. Therefore, the preceding detailed description is not to be taken in the limiting sense, and the scope of embodiments is defined by the appended claims and their equivalents

What is claimed is:

1. A non-transitory computer readable media having instructions stored thereon that, when executed by one or more computer processing components, cause the one or more computer processing components to perform a method for mitigating atmospheric ducting interference occurring within a telecommunications network, the method comprising:
predicting that time of flight (TOF) interference will occur at a first time;
determining that a user equipment (UE) within a coverage area of a victim base station is configured to communicate with the victim base station using a primary cell and a secondary cell, wherein the primary cell and the secondary cell are both configured to use frequency domain duplexing (FDD);
instructing, at a time prior to the first time, the victim base station to re-configure the primary cell to use time domain duplexing (TDD);
determining that the TOF interference is occurring for the victim base station; and
based on the determining that the TOF interference is occurring for the victim base station, causing a scheduler associated with the victim base station to communicate to the UE that all uplink communication to be sent from the UE to the victim base station is scheduled to be sent via the secondary cell and no uplink communication to be sent from the UE to the victim base station is scheduled to be sent via the primary cell.

2. The non-transitory computer readable media of claim 1, wherein the predicting involves forecasting a likelihood of TOF interference based on historical data patterns.

3. The non-transitory computer readable media of claim 1, wherein the determining that TOF interference is occurring for the victim base station comprises evaluating a signal strength and a quality of service for the victim base station.

4. The non-transitory computer readable media of claim 3, wherein determining that TOF interference is occurring further comprises analyzing atmospheric conditions, historical data patterns, and real-time sensor readings.

5. The non-transitory computer readable media of claim 1, wherein the instructing the UE at the time prior to the first time to re-configure the primary cell to use the TDD includes sending control signals to the UE to switch an operating mode for the primary cell from the FDD to the TDD.

6. The non-transitory computer readable media of claim 1, the method further comprising adjusting a scheduling of uplink communication from the UE based on the prediction of TOF interference.

7. The non-transitory computer readable media of claim 1, further comprising determining that the TOF interference has fallen below a pre-determined threshold.

8. The non-transitory computer readable media of claim 7, further comprising reverting the primary cell to use the FDD after the TOF interference has fallen below the pre-determined threshold.

9. The non-transitory computer readable media of claim 1, further comprising monitoring a quality of service experienced by the UE during the TOF interference.

10. A system in a wireless telecommunication network, the system comprising:
a victim base station configured to wirelessly communicate with a user equipment (UE); and
one or more computer processing components configured to perform operations comprising:
determining, at a first time, that a time of flight (TOF) interference is occurring for the victim base station, wherein the victim base station is configured to operate using a primary cell and a secondary cell, wherein the primary cell is configured to use time domain duplexing (TDD) and the secondary cell is configured to use frequency domain duplexing (FDD); and
based on the determining that the TOF interference is occurring for the victim base station, causing a scheduler associated with the victim base station to communicate to the UE that all uplink communication to be sent from the UE to the victim base station is scheduled to be sent via the secondary cell and no uplink communication to be sent from the UE to the victim base station is scheduled to be sent via the primary cell.

11. The system of claim 10, wherein determining that TOF interference is occurring includes analyzing atmospheric conditions, historical data patterns, and real-time sensor readings.

12. The system of claim 10, further comprising instructing the UE to switch the primary cell from the FDD to the TDD at a time prior to the first time.

13. The system of claim 12, further comprising modifying resource allocation protocols when instructing the UE to switch the primary cell from the FDD to the TDD.

14. The system of claim 10, further comprising modifying control signals to communicate the scheduling of the uplink communication to the UE.

15. The system of claim 10, further comprising reverting the primary cell to use the FDD after the TOF interference has fallen below a pre-determined threshold.

16. A method for mitigating tropospheric ducting interference in a wireless telecommunication network, the method comprising:
monitoring a set of environmental parameters to predict an occurrence of time of flight (TOF) interference at a future time;
identifying a user equipment (UE) within a service range of a victim base station, where the victim base station operates with a primary cell using time domain duplexing (TDD) and a secondary cell using frequency domain duplexing (FDD);
verifying an occurrence of the TOF interference;
directing a scheduler associated with the victim base station, in response to the TOF interference, to reallocate uplink communication channels such that the UE is instructed to transmit exclusively via the secondary cell.

17. The method of claim 16, wherein the monitoring the set of environmental parameters comprises collecting a plurality of atmospheric data from weather prediction services and integrating the plurality of atmospheric data with historical network performance metrics.

18. The method of claim 16, wherein the verifying the occurrence of the TOF interference comprises analyzing signal degradation metrics and error rates over the primary cell.

19. The method of claim 16, further comprising reverting the primary cell to use the FDD after the TOF interference has fallen below a pre-determined threshold.

20. The method of claim 16, further comprising monitoring a quality of service experienced by the UE during the TOF interference.
